(19) United States
(12) Patent Application Publication
(10) Pub. No.: US 2024/0061430 A1
(43) Pub. Date: Feb. 22, 2024

(54) METHOD AND DEVICE FOR EVENT DETECTION

(71) Applicant: Telefonaktiebolaget LM Ericsson (publ), Stockholm (SE)

(72) Inventor: Ning Zhang, Beijing (CN)

(21) Appl. No.: 18/269,789

(22) PCT Filed: Dec. 29, 2020
(86) PCT No.: PCT/CN2020/140779

§ 371 Date: Jun. 27, 2023

(51) Int. Cl. G05D 1/02; G05D 1/12

(52) U.S. Cl. CPC G05D 1/0212; G05D 1/12; G05D 2201/0207; G05D 2201/0209

(57) ABSTRACT

Various embodiments of the present disclosure provide a method performed by a management system. The method comprises instructing at least one robot, which may be a drone, a land robot or an underwater robot, to patrol a path for event detection based on a path database maintained according to people's activities within a predefined area and obtaining data from the at least one robot. The method also comprises detecting an event based on the data obtained from the at least one robot and reporting the event to e.g. any of a person, a police station, rescue people and a server.

### TECHNICAL FIELD

Embodiments of the present disclosure generally relate to the field of smart environment in Internet of Things (IoT) area and particularly, to a method and management system for event detection.

### BACKGROUND

This section introduces aspects that may facilitate better understanding of the present disclosure. Accordingly, the statements of this section are to be read in this light and are not to be understood as admissions about what is in the prior art or what is not in the prior art.

Blaze and unauthorized or illegal logging may be major factors that would destroy or damage forest. Especially, blaze may even result in a disaster of human lives and ecosystem, no matter it's caused by wildfire or arson.

Currently, forest policemen and managers, local government as well as fire brigade make huge efforts to patrol forest areas, publicize harmful consequences of illegal use of fire to forest visitors and deploy numerous cameras to monitor potential dangers. However, due to the vast area of the forest, it's rather hard to discover a potential danger timely and help people avoid or escape from the danger.

In most cases, the authority has to rely on human resources to patrol and monitor the forest area which is in potential danger, discover a suspicious fire source and/or send pre-warning messages to both forest visitors, fire brigade, and/or forest managers etc.

This would be somehow a waste of human resources in most cases. But it's really needed when an urgent situation is happening. The difficulty for the authority is that though a large number of people are protecting the vast area of forest, it's still very low efficient at discovering a fire source. In many cases, the fire source is discovered when a blaze is already started, which leads to a huge damage to the forest, and even to human lives. Moreover, it will take several years for the forest to fully recover to its original vegetation coverage.

It is difficult to stop people to travel through a forest due to its vast area. It's also impossible to build up a fence around such vast area for closed protection. In recent years, drones with cameras are used to patrol the forest area, but the efficiency is still not high.

On the other hand, when a blaze is formed, its spread speed would be very fast. People traveling within the forest may not have time to find a way to escape. The endangered people may lose a direction in panic and the rescuing team may not know where the people are. In addition to the forest, human patrolling in a vast area is a routine job which may cause a person feeling bored so that he/she may miss some important suspected factors which would finally result in a real danger. Also, even if the job is assisted by robots such as drones, due to the vast area, it's rather hard to cover all areas that are subjected to potential dangers.

### SUMMARY

In order to solve at least part of the above problems, various embodiments of the present disclosure propose a method for event detection. Though the method is proposed in the context of forest protection, the method can also be applied to other scenarios where a vast area needs to be monitored for event detection, such as a sea, a lake, a grassland, a vast forbidden military area etc. It shall be appreciated the term “event” may have a broad meaning, including but not limited to, a (potential) danger which may cause a blaze in the forest, a shipwreck in the sea, an explosion etc., resulting in natural environment damage, property loss and/or threatening human lives or other events which may need urgent handling or intervention.

In a first aspect of the present disclosure, there is provided a method for event detection. The method comprises instructing at least one robot, which may be a drone, a land robot or an underwater robot, to patrol a path for event detection based on a path database maintained according to people's activities within a predefined area and obtaining data from the at least one robot. The method also comprises detecting an event based on the data obtained from the at least one robot and reporting the event to e.g. any of a person, a police station, rescue people and a server.

In an embodiment, the method may further comprise prompting a person entering into the predefined area to install an application on a communication device of the person and receiving via the application installed on the communication device a report indicating an event within the predefined area. The method may also comprise updating the path database with the received report. In another embodiment, the path database may be updated with the data obtained from the at least one robot.

In an embodiment, the predefined area may be deployed with at least one base station, which is capable of providing communication to the person's communication device and/or charging the at least one robot.

In an embodiment, the at least one robot may comprise a border robot that monitors a person's entrance and exit to the predefined area and a tracking robot that monitors the person's activities along a certain path within the predefined area.

In an embodiment, the method may further comprise detecting a person's entrance and exit to the predefined area. In such embodiment, the at least one robot to patrol the path for event detection may be instructed in response to the detection of the person's entrance to the predefined area.

In an embodiment, the method may further comprise removing obsolete data, from the path database, indicating a path which was not visited for a predefined period.

In an embodiment, a robot of the at least one robot may be equipped with one or more sensors for collecting environment information.

In a second aspect of the present disclosure, there is provided a management system. The management system comprises a processor and a memory. The memory contains instructions executable by the processor whereby the management system is operative to instruct at least one robot to patrol a path for event detection based on a path database maintained according to people's activities within a predefined area, obtain data from the at least one robot, detect an event based on the data obtained from the at least one robot and report the event.

In a third aspect of the present disclosure, there is provided a computer program product. The computer program product is tangibly stored on a computer readable storage medium and includes instructions which, when executed on at least one processor, cause the at least one processor to carry out the method according to the first aspect of the present disclosure.

According to various embodiments of the present disclosure, a vast area like a forest can be efficiently and automatically protected by robots.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a method for event detection according to embodiments of the present disclosure;

FIG. 2 illustrates a typical scenario where method 100 could be applied according to an embodiment of the present disclosure;

FIG. 3 shows a patrolling path network illustrating how robots patrol a predefined forest area according to an embodiment of the present disclosure;

FIG. 4 shows an example illustrating how the management system invoke robots to monitor a person who enters the predefined forest area according to an embodiment of the present disclosure;

FIG. 5 shows an example illustrating how tracking robots track people according to an embodiment of the present disclosure;

FIG. 6 shows an example illustrating how tracking robots help people to escape according to an embodiment of the present disclosure; and

FIG. 7 shows a block diagram of a management system according to embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms “a”, “an” and “the” are intended to include the plural forms as well, unless the context clearly indicates otherwise. The term “includes” or “comprises” and its variants are to be read as open terms that mean “includes/comprises, but not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

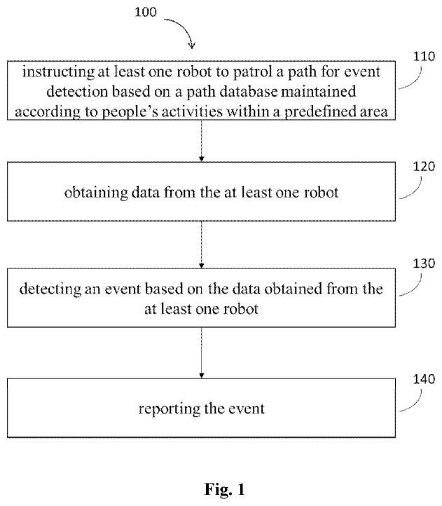

FIG. 1 illustrates a method 100 for event detection according to embodiments of the present disclosure. The “event” used herein may refer to, but not limited to, a (potential) danger due to human's activities which may cause a blaze in the forest, a shipwreck in the sea, an explosion etc., resulting in natural environment damage, property loss and/or threatening human lives or other events which may need immediate handling or intervention. The method may be performed by a management system, e.g. a forest management system, which may be implemented in software, firmware or hardware and may be implemented as/in a standalone device, as/in several distributed devices or within a base station.

As illustrated, the method 100 comprises instructing, at block 110, at least one robot to patrol a path for event detection based on a path database maintained according to people's activities within a predefined area. The instructing may be performed in response that entrance of a person (e.g. a traveler) is detected by a robot patrolling along the border of the predefined area. The at least one robot may be a land robot, an underwater robot or a drone, depending on application scenarios.

The method 100 further comprises obtaining, at block 120, data from the at least one robot and detecting, at block 130, an event based on the data obtained from the at least one robot, and then reporting, at block 140, the event, e.g. to a person (e.g. a traveler) entering the predefined area, a server, a police station, and/or rescue people.

In an embodiment, the method 100 may comprise prompting a person entering into the predefined area to install an application on a communication device of the person, and receive via the application installed on the communication device a report indicating an event within the predefined area. The method 100 may also comprise updating the path database with the received report. The path database may be updated with the data received from the at least one robot.

In an embodiment, the predefined area may be deployed with at least one base station, which is capable of providing communication to the person's communication device and/or charging the at least one robot.

In an embodiment, the at least one robot may comprise a border robot that monitors a person's entrance or exit to the predefined area and a tracking robot that monitors the person's activities along a certain path within the predefined area.

In an embodiment, the method 100 may comprise removing obsolete data, from the database, indicating a path which was not visited for a predefined period, e.g. a few days, or a few hours.

In an embodiment, a robot of the at least one robot may be equipped with one or more sensors for collecting environment information and may send the environment information to the management system. The environment information may include but not limited to information on surrounding temperature, carbon dioxide (CO₂) density, air humidity and soil moisture, and/or activities of humans or animals who are present in the surrounding area. In the following, specific examples will be given to describe some implementation details of method 100 in particular application scenarios. Though the examples are described in the context of forest, it shall be appreciated that the method can also be applied in other contexts where a vast area needs to be monitored for event detection, such as a sea, a lake, a grassland, a vast forbidden military area etc. It shall also be appreciated that the scope of the present disclosure shall not be limited to a specific detailed example.

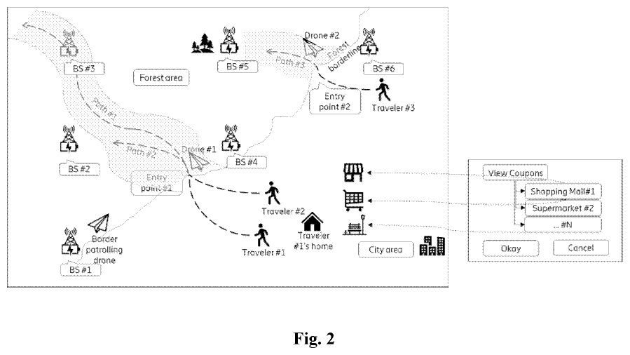

FIG. 2 illustrates a typical scenario where method 100 could be applied according to an embodiment of the present disclosure.

As shown in FIG. 2, there are six base stations BS #1˜BS #6 deployed in a predefined forest area. Base stations BS #1, BS #4, and BS #6 are on the border of the predefined forest area and base stations BS #2, BS #3 and BS #5 are within the forest area. The base stations may be 5G base stations providing a wider bandwidth so that it is possible to deliver high resolution images or videos with a less delay.

Each of the base stations may be equipped with a battery charger for charging robots, such as drones #1 and #2. When the drones are running out of battery, they could find the nearest base station for battery charging.

Take traveler #1 as an example, he is leaving home to the predefined forest area. When he is near the base station BS #4 which is deployed on the forest border, his mobile phone is switched to B S #4 for network access. Then, BS #4 may send a message to traveler #1 to prompt him whether he agrees to install an application provided from a forest management system, thus some of his personal information may be read via the application. If it is agreed, traveler #1 may use the link sent in the message to download and install the application. The application may obtain, under an agreed privacy policy, information from messages/audios/videos used by traveler #1 and send such information to the forest management system to determine the purpose of his visit. The application may also determine this purpose based on the messages/audios/videos used by traveler #1 and report the purpose to the forest management system.

In addition, the application may encourage by prompting traveler #1 to share his information and travel path (e.g. “Path #1”) with other travelers and/or the management system. In some cases, the application may reward the traveler for this sharing action, e.g. by giving him some coupons of commercial places that are close to his home, e.g. shopping mall #1 and supermarket #2. This may require cooperation between forest management bureau and these commercial places, which may be a win-win deal for the forest management bureau in the form of advertisement. If the traveler refuses to install this application, then the base station providing services to the traveler can still know his position as usual.

When the management system, from the information obtained via the application, finds that traveler #1 is going to have a picnic, it will instruct at least one robot, e.g. a drone and/or a land robot, to patrol path #1 of traveler #1 for event detection based on a path database. If traveler #1 has shared his path, the at least one robot may patrol along the shared path. The shared path may be added into the path database. The path database is maintained according to people's activities within the predefined forest area. For example, if a traveler explores a new path which is not existing in the current path database, this new path will be patrolled by a robot and added into the path database.

The management system obtains data from the at least one patrolling robot. Based on the data obtained from the at least one robot, a potential danger, e.g. a fire source may be detected. Then the management system will report the danger to the traveler via the installed application or by sending a message if the application is not installed or by broadcasting. The danger may also be reported to a server, a police station, and/or fire brigade.

In particular, the width of a patrolling path can be defined according to the traveler's activity range and based on the path database.

As shown in FIG. 2, the path for traveler #1 may be patrolled and stored into the path database, which may be named as “Known Path Database” (KPD). In practice, the successor traveler #2 to the predefined forest area may follow traveler #1's path as it's simpler and safer. Also, traveler #2 may explore a new path as marked “Path #2” in FIG. 2. In this example, Path #2 is quite close to Path #1. Thus, a same drone may be used to patrol the path of traveler #2, which may save some resources. Similarly, other traveler #3 may explore a new entry point (Entry point #2) as well as a new path (Path #3). Since Path #3 is far away and not overlapped with the existing patrolling path, the management system may instruct a separate drone for patrolling path #3.

The path database may comprise two parts: KPD and “Obsoleted Path Database” (OPD). The paths stored in KPD can be de-activated by a predefined timer indicating that a predefined time period has passed, and the corresponding path is obsolete. The paths stored in OPD can be re-activated when they are re-used by travelers.

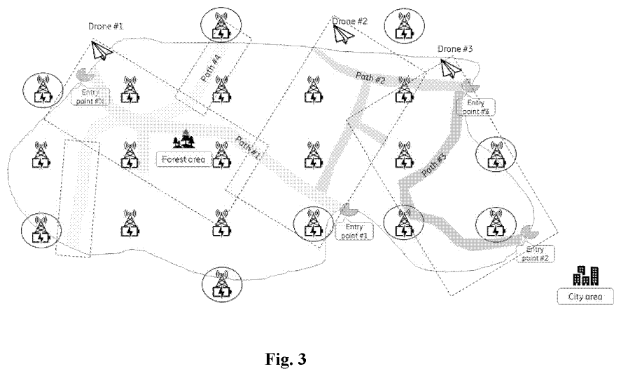

Thus, according to people's activities, a patrolling path network as illustrated in FIG. 3, which may be named as “Patrolling Path Network”, may be created and stored in the path database for later use. FIG. 3 shows a “Patrolling Path Network” illustrating how robots, e.g. drones, land robots or underwater robots, patrol the predefined forest area according to an embodiment of the present disclosure.

As shown in FIG. 3, the predefined forest area is deployed with several base stations inside and on its border. The base stations on the border are circled in the figure. The legal entry points #1˜N to the predefined forest area are also shown.

In FIG. 3, there are two types of robots which take the responsibility for forest protection. The first type is border robots, which are shown as border patrolling drones #1, #2 and #3) in FIG. 3 monitoring the traveler's entrance and exit to the forest area. If there is a new entry point found, there shall be a new path through the forest which will be added to the path network. The second type is tracking robots, which are particularly “tracking drones” in this example for tracking the traveler along a certain path and detect risky actions. Also, the second type of robots may also be responsible for people's escaping from dangers and leading the rescue team or the fire brigade into the fire scene.

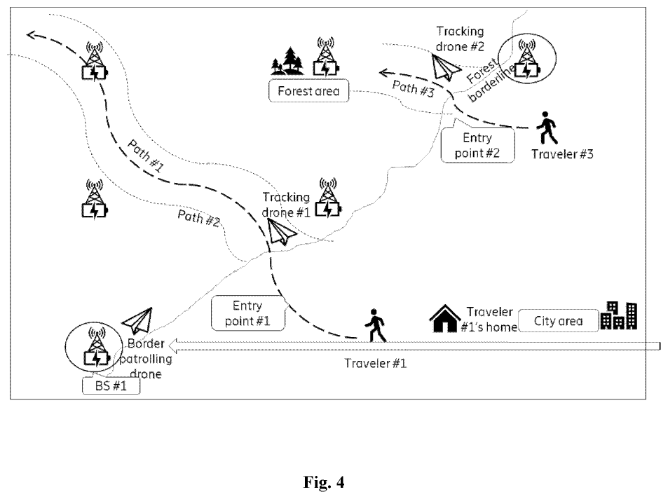

FIG. 4 shows an example illustrating how the management system invoke robots to monitor a person who enters the predefined forest area according to an embodiment of the present disclosure.

As shown in FIG. 4, when a border patrolling drone finds traveler #1 entering the forest area, it will send a message via the nearby base station BS #1 or other local wireless connection to the management system. The management system then accordingly instructs tracking drone #1 which may be equipped with an infrared camera to capture, track and monitor traveler #1. Since human body's temperature is usually higher than vegetation, it's easier to locate the traveler by using the infrared camera within a limited area, which may also be assisted by the path database.

Meanwhile, the base station BS #1 may encourage traveler #1 to install an application for forest protection when he is close to the forest area and track the traveler via the application in the forest area, as aforementioned.

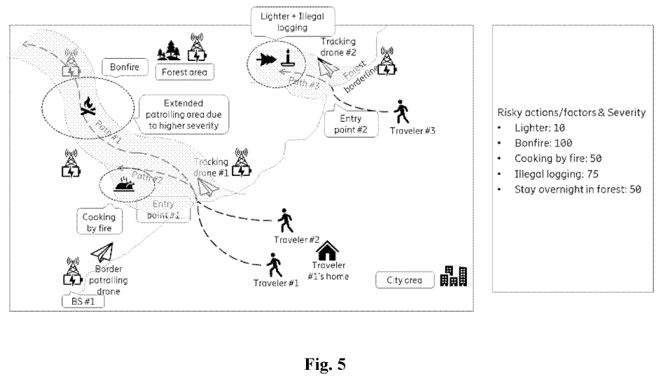

FIG. 5 shows an example illustrating how tracking robots track people according to an embodiment of the present disclosure.

In this example, a table that includes definitions of all risky actions of human beings and corresponding severity levels is maintained in the path database which may be stored in the robots or in a central server. The table may be input by a forest manager based on statistical real facts. For example, for use of a lighter, the corresponding severity level is 10; for bonfire, the severity level is 100; for cooking by fire, the severity level is 50; for illegal logging, the severity level is 75; and for staying overnight, the severity level is 50.

As shown, tracking drone #1 may patrol along path #1 with an extended width or an area based on the severity level as defined, e.g. severity level 100 of bonfire. If traveler #1 is taking an illegal action, such as bonfire or logging, tracking drone #1 will send a message to the forest management system and/or the police station etc. The message may include a video showing traveler #1's action and his accurate location. Meanwhile, the traveler will also be prompted to cease the dangerous actions and later upload the properly handled scene pictures or videos via the application to the forest management system. For example, a photo showing that the scene is cleaned up after cooking without any potential fire danger shall be uploaded.

Tracking drone #1 may also send the path information of traveler #1 to the management system for storing in the path database. Tracking drone #1 may patrol in a predefined pattern according to the path database, especially when there are more people (e.g. traveler #2) are walking along this way.

When there are several paths to be patrolled according to the path database, the area to be patrolled may be divided into sections that have similar area so that each tracking drone can work with a balanced workload. For example, tracking drone #1 may patrol the area along path #1 and path #2 for traveler #1 and traveler #2, and tracking drone #2 may patrol the area along path #3 for traveler #3. This may have an advantage: with a certain number of drones, the balanced patrolling area may decrease the total time to be taken for danger detection. The balanced workload may balance or extend the life cycle of each drone.

Similarly to the boarder patrolling drones, when a certain path isn't visited by people for a predefined period, it might be considered as obsolete and the corresponding data for these paths shall be moved to OPD. And if any path in OPD is re-used, the corresponding data shall be re-activated to KPD.

In some examples, the tracking drones may also take the responsibility of tracking and monitoring environment and vegetation status. They could collect environment information such as information on surrounding temperature, CO₂ density, air humidity, soil moisture, and/or activities of humans or animals who are present in the surrounding area, from the sensors carried thereon. The environment information will be used for analyzing whether there will be a high possibility of wildfire. For example, the ignition threshold temperature of wood is about 180 Celsius which is much higher than the ambient temperature. By sensing the surrounding temperature, a fire source could be detected. As another example, in summer, if the air humidity and soil moisture are rather low while the temperature is high, when a drone discovers a large area with dead vegetation, it would have a high possibility of wildfire after thunderbolts. When such environment information is collected and sent to the forest management system, the management system may take an action to avoid a fire disaster.

Also, at the beginning phase of a blaze, even the tracking drone does not discover a fire source but it may detect high density of carbon dioxide. Such information may warn the management system to take an action.

Moreover, the drones with cameras may discover some pests which would destroy a certain area of vegetation. They will send alerts to the forest management system, which may further encourage the people who have installed the application as volunteers to discover and report via the installed application such kinds of harmfulness to the forest manually.

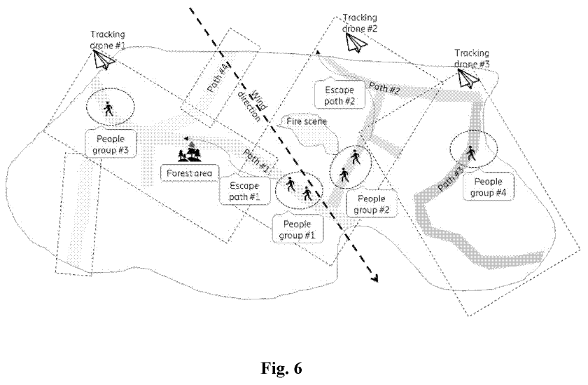

FIG. 6 shows an example illustrating how tracking drones help people to escape when a fire source or blaze is discovered according to an embodiment of the present disclosure.

As shown in FIG. 6, the fire scene is located in the center of the forest area as defined. There are two groups of people (People group #1 and People group #2) moving in the wind direction and in danger, while the other two groups (People group #3 and People group #4) are far away. Tracking drone #2 patrolling along path #2 may find the fire and thus report some environment information like the wind direction and the location of the fire scene to the management system. The management system will accordingly propose a safety escape path for the endangered people groups #1 and #2. The proposed escape path may be indicated via the application. For the other two groups (groups #3 and #4) of people, the management system may warn them that there is a fire and indicate the location of the fire scene via the application if installed or by broadcasting otherwise. The people groups #3 and #4 may avoid moving close to the fire scene.

Meanwhile, tracking drone #1 or #2 can guide the endangered people to escape. If anyone is off track, the tracking drone may notify him/her and provide dedicated information to help him/her back to track. All people's accurate information such as their locations during the entire escaping procedure may be sent to the forest management system as well as the fire brigade to prevent anyone's missing in the fire.

In addition, according to various embodiments of the present disclosure, a new business model may be established. In this business model, there are three parties: a forest management bureau, visitors and commercial organizations. Previously, these three parties may have a very loose connection. The bureau costs a lot to prevent visitors from dangerous activities such as using firelighters in the forest. However, visitors tend to explore new areas of the forest which makes the management rather difficult. Moreover, the commercial organizations don't participate in this management which means many business opportunities are undiscovered.

This business model combines the three parties together. The bureau encourages visitors to share their travel paths to others. If the visitors obey the law and regulations, they may be rewarded, e.g. with a certain discount or coupon from the commercial organizations. In the meanwhile, the commercial organizations can publish advertisements to attract visitors to their stores via the bureau.

In this way, the bureau may cost fewer human resources to patrol and monitor the forest and even have extra income from the commercial organizations. The visitors may obtain more benefits in the forest by “sacrificing” their limited privacy during the entire visit to the forest. Meanwhile, the visitors may get a discount or a coupon from the commercial organizations. As a result, the visitors may be encouraged to obey the law and regulations in a more comfortable way. The commercial organizations may extend their business to those people who are far away from their stores. A win-win relationship may be established among the three parties.

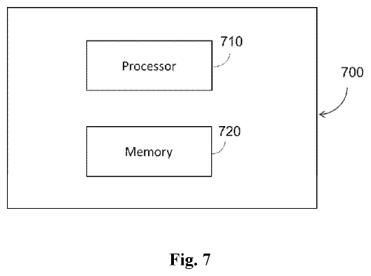

FIG. 7 shows a block diagram of a management system according to embodiments of the present disclosure. The management system may be implemented in software, firmware or hardware and may be implemented as/in a standalone device, as/in several distributed devices or within a base station.

As illustrated, the management system comprises a processor 710, and a memory 720. The memory 720 contains instructions executable by the processor 710 whereby the management system is operative to perform the actions, e.g., of the method 100 as described in connection with FIG. 1.

In an embodiment of the present disclosure, the memory 720 contains instructions executable by the processor 710 whereby the management system is operative to instruct at least one robot, which may be a land robot, an underwater robot or a drone, to patrol a path for event detection based on a path database maintained according to people's activities within a predefined area, obtain data from the at least one robot, detect an event based on the data obtained from the at least one robot, and report the event to e.g. a person, a police station, rescue people or a server.

In an embodiment, the memory may contain instructions executable by the processor whereby the management system is further operative to prompt a person entering into the predefined area to install an application on a communication device of the person and receive via the application installed on the communication device a report indicating an event within the predefined area, and update the path database with the received report. The path database may also be updated with the data obtained from the at least one robot.

In an embodiment, the predefined area may be deployed with at least one base station, which is capable of providing communication to the person's communication device and/or charging the at least one robot.

In an embodiment, the at least one robot comprises a border robot that monitors a person's entrance and exit to the predefined area and a tracking robot that monitors the person's activities along a certain path within the predefined area.

In an embodiment, the memory may contain instructions executable by the processor whereby the management system is further operative to detect a person's entrance and exit to the predefined area. So the management system may instruct the at least one robot to patrol the path for event detection in response to the detection of the person's entrance to the predefined area.

In an embodiment, the memory may contain instructions executable by the processor whereby the management system is further operative to remove obsolete data, from the path database, indicating a path which wasn't visited for a predefined period.

In an embodiment, a robot of the at least one robot may be equipped with one or more sensors for collecting environment information. The environment information may include but not limited to information on surrounding temperature, carbon dioxide (CO₂) density, air humidity and soil moisture, and/or activities of humans or animals who are present in the surrounding area.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the management system 700, there may be several physically distinct memory modules in the management system 700. The processor 710 may be of any type suitable to the local technical network, and may include one or more of general-purpose computers, special purpose computers, microprocessors, digital signal processors (DSPs) and processors based on multicore processor architecture, as non-limiting examples. The management system 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides a computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 710 causes the management system to perform actions, e.g., of the method described earlier in conjunction with FIG. 1.

The computer program product may be configured as a computer program code structured in computer program modules. The computer program modules could essentially perform the actions of the flow illustrated in FIG. 1.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for event detection, comprising:
instructing at least one robot to patrol a path for event detection based on a path database maintained according to people's activities within a predefined area;
obtaining data from the at least one robot;
detecting an event based on the data obtained from the at least one robot; and
reporting the event.

2. The method according to claim 1, further comprising:
prompting a person entering into the predefined area to install an application on a communication device of the person;
receiving via the application installed on the communication device a report indicating an event within the predefined area; and
updating the path database with the received report.

3. The method according to claim 1, further comprising: updating the path database with the data obtained from the at least one robot.

4. The method according to claim 1, wherein the at least one robot comprises a drone, a land robot and/or an underwater robot.

5. The method according to claim 4, wherein,
the predefined area is deployed with at least one base station, which is capable of providing communication to the person's communication device and/or charging the at least one robot.

6. The method according to claim 1, wherein the at least one robot comprises a border robot that monitors a person's entrance and exit to the predefined area and a tracking robot that monitors the person's activities along a certain path within the predefined area.

7. The method according to claim 6, further comprising:
detecting a person's entrance and exit to the predefined area; and
wherein instructing the at least one robot to patrol the path for event detection comprises instructing the at least one robot to patrol the path for event detection in response to the detection of the person's entrance to the predefined area.

8. The method according to claim 1, further comprising:
removing obsolete data, from the path database, indicating a path which wasn't visited for a predefined period.

9. The method according to claim 1, reporting the event comprises:
reporting the event to any of a person, a police station, rescue people, and a server.

10. The method according to claim 1, wherein a robot of the at least one robot is equipped with one or more sensors for collecting environment information.

11. A management system, comprising:
a processor; and
a memory, the memory containing instructions executable by the processor whereby the management system is operative to:
instruct at least one robot to patrol a path for event detection based on a path database maintained according to people's activities within a predefined area;
obtain data from the at least one robot;
detect an event based on the data obtained from the at least one robot; and
reporting the event.

12. The management system according to claim 11, wherein the memory contains instructions executable by the processor whereby the management system is further operative to:
prompt a person entering into the predefined area to install an application on a communication device of the person;
receive via the application installed on the communication device a report indicating an event within the predefined area; and
update the path database with the received report.

13. The management system according to claim 11, wherein the memory contains instructions executable by the processor whereby the management system is further operative to:
update the path database with the data obtained from the at least one robot.

14. The management system according to claim 11, wherein the at least one robot comprises a drone, a land robot and/or an underwater robot.

15. The management system according to claim 14, wherein the predefined area is deployed with at least one base station, which is capable of providing communication to the person's communication device and/or charging the at least one robot.

16. The management system according to claim 11, wherein the at least one robot comprises a border robot that monitors a person's entrance and exit to the predefined area and a tracking robot that monitors the person's activities along a certain path within the predefined area.

17. The management system according to claim 16, wherein the memory contains instructions executable by the processor whereby the management system is further operative to:
detect a person's entrance and exit to the predefined area; and
wherein instructing the at least one robot to patrol the path for event detection comprises instructing the at least one robot to patrol the path for event detection in response to the detection of the person's entrance to the predefined area.

18. The management system according to claim 11, wherein the memory contains instructions executable by the processor whereby the management system is further operative to:
remove obsolete data, from the path database, indicating a path which was not visited for a redefined period.

19. The management system according to claim 11, wherein the event is reported to any of a person, a police station, rescue people, and a server.

20. The management system according to claim 11, wherein a robot of the at least one robot is equipped with one or more sensors for collecting environment information.

21. (canceled)
